(19) United States
(12) Patent Application Publication
(10) Pub. No.: US 2005/0104000 A1
(43) Pub. Date: May 19, 2005

(54) Scintillator assembly with pre-formed reflector

(76) Inventors: Joel Kindem, San Diego, CA (US); Lars S. Carlson, San Diego, CA (US)

Correspondence Address: FISH & RICHARDSON, PC, 12390 EL CAMINO REAL, SAN DIEGO, CA, 92130-2081, US

(21) Appl. No.: 10/776,645

(22) Filed: Feb. 10, 2004

Related U.S. Application Data
(60) Provisional application No. 60/446,461, filed on Feb. 10, 2003.

(51) Int. Cl. G01T 1/20

(52) U.S. Cl. 250/361 R; 250/367; 250/368

(57) ABSTRACT

A scintillator assembly with at least one scintillator pixel. A reflector is preformed, and at least a portion of the scintillator material fits within the preformed reflector. The reflector assembly may have a single pre-formed unit or a plurality of subassemblies, one or a plurality of which having been pre-formed prior to insertion of one or a plurality of scintillator pixels. The reflector assembly may provide for the formation of intentional air gaps between one or a plurality of reflector walls and one or a plurality of scintillator pixels.

### CROSS-REFERENCE TO RELATED APPLICATION

This application claims benefit of the priority of U.S. Provisional Application Ser. No. 60/446,461 filed Feb. 10, 2003 and entitled “Pre-formed Reflector for Scintillator.”

### TECHNICAL FIELD

The present disclosure relates to electromagnetic radiation detectors, and more specifically to scintillator assemblies used to generate light as part of the detection process in such detectors, each assembly comprised of one or a plurality of scintillator pixels, the surface area of which is partially covered by reflective material to enhance the light output of the pixels or for other purposes.

### BACKGROUND

Many electromagnetic radiation detectors employ an indirect detection method, in which the final detection device responds to light generated by a scintillating material in response to an incident electromagnetic particle. The scintillating material converts parts of the energy of an incident electromagnetic particle into light, typically in the near infrared, visible or ultraviolet range of wavelengths, which is then detected by a photodetector such as a photodiode or photomultiplier tube.

Many applications of electromagnetic radiation detectors, such as X-ray computed tomography (CT) systems, X-ray baggage scanners and gamma-ray imaging systems, employ large numbers of individual pieces of scintillator material, referred to herein as scintillator pixels. In such applications, it is common to form arrays, referred to herein as scintillator arrays, comprising a plurality of scintillator pixels. These arrays are then coupled optically to a plurality of individual photodetectors or to an integrated array of photodetectors. In some embodiments, one or a plurality of scintillator arrays may be coupled to a single photodetective element such as a photomultiplier tube.

Many scintillator assemblies comprise one scintillator pixel or a scintillator array, the surface area of which is partially covered by a reflective material. The reflective material may comprise a single component or a homogeneous or inhomogeneous mixture of components. In response to an incident “primary” photon or particle, each scintillator pixel emits secondary “scintillation” photons -from a selected area or areas of the pixel surface area referred to as an exit window or windows. The reflective material at least partially covers the remainder of the scintillator surface area and reflects scintillation photons incident on the covered area back into the scintillator. The term reflector herein denotes either the reflective material itself or the entirety of the reflector material covering the scintillator pixel or scintillator array. The reflector therefore increases the light output from the exit window or windows above the output that would occur without the reflector. Reflectors may perform additional functions such as radiation shielding. Use of the reflector for such functions may result in a reduction of light output.

Known techniques to “reflectorize” the surface of one or a plurality of scintillator pixels include (a) wrapping scintillators with reflective materials such as Teflon tape, (b) applying sheet reflective materials to the scintillator surfaces, either by placing the reflector in close proximity to the scintillator surface or by attaching the reflector to the scintillator surface with, for example, an appropriate adhesive; (c) casting the reflector in place using for example reflective paste, reflective gels or reflective solids, such as cured epoxy filled with titanium dioxide, to surround the scintillator material, except for the exit window or windows, and (e) painting, depositing or otherwise forming a layer of reflective material on a supporting or backing medium such as a plastic or metal. For brevity, structures of this type will be referred to as “coated” reflectors. Coated reflectors of appropriate geometry and materials may subsequently be used as foil, tape or other compatible form in wrapped reflectors or as sheets for sheet reflectors. In principle, a liquid reflector could be used, provided that it has the desired reflectivity and is appropriately confined to the desired areas of application.

The discussion below assumes a rectangular array of rectangular scintillator pixels, referred to below as a scintillator array, with more than one pixel in each of two perpendicular horizontal directions, referred to below as x and y. Gaps, called septa, may separate each scintillator pixel from its neighboring pixels, providing a space within which reflective material may be applied. The bottom face of each pixel, located in a plane parallel to the x-y plane, functions as the exit window for that pixel. Reflectorizing the scintillator assembly is performed by applying reflector material to all surfaces of the individual pixels other than the face used as the exit window, referred to below as the exit face. The face opposite the exit face is referred to as the top face. This discussion does not address the processes required to form the faces or septa of the scintillator pixels. The direction perpendicular to the x- and y-directions is referred to as the z-direction.

The teachings given herein are not limited to scintillator arrays or to rectangular scintillator assemblies. The teachings given herein can also be applied to a single pixel scintillator, of any shape or size.

Previous techniques may be labor-intensive. Teflon tape can be wrapped around the vertical sides of a single scintillator pixel with relative ease. In the scintillator assembly of the example, the goal typically is to have the same number of layers, or at least a specified minimum thickness of reflector, on all the adjacent vertical faces. This allows the array to be bound by clamping together or otherwise constraining the individual pixels into a scintillator assembly of the desired number of pixels and shape. The reflector on the top face may be formed by applying a single piece of tape of the appropriate thickness or several pieces of tape overlapped to ensure that each pixel is covered by the minimum desired thickness of reflector. The top tape may overlap the vertical sides of the assembly and may be secured by wrapping additional layers of tape around the periphery of the vertical sides of the assembly. An additional layer or layers of tape may be applied to the exterior of the assembly, for example to provide, or to contribute to, a method of binding. This method of fabrication requires a large number of steps, because each individual scintillator pixel must be wrapped, in addition to the steps required to cover the top face. In some embodiments, the reflector may be attached to the top face using a transparent adhesive. Teflon tape is particularly difficult to bond using adhesives. Teflon typically discolors during adhesive bonding, thereby degrading its reflectivity.

Applying a uniform number of layers or a specified minimum thickness of tape to the vertical sides of the pixels of a scintillator array without wrapping each individual pixel would be very difficult in many instances, because the desired configuration of the reflector cannot be produced using a single piece of tape, especially if the number of layers of tape on each surface of the array must be identical. One method for avoiding this difficulty is to use a semi-rigid or rigid sheet reflector material.

Fabricating a scintillator assembly from a scintillator array using sheet reflectors typically requires (a) cutting or otherwise forming long “rows” of scintillator material of the desired width, typically by forming one or more parallel grooves in a single solid “blank” of scintillator material, (b) inserting (with or without attaching by adhesives) strips of sheet reflector material between these rows, (c) segmenting the rows into pixels by cutting or otherwise forming grooves perpendicular to the grooves used to form the initial rows, (d) inserting (with or without bonding) strips of reflector into the grooves formed in (c) and to the end faces of the array not previously covered, (e) applying (with or without bonding) strips of reflector to the periphery of the array of pixels, (f) cutting, grinding or otherwise finishing the array to the desired dimension between top and bottom faces, (g) applying (with or without bonding) a strip of reflector to the top face, (h) cutting the strips applied in (e) and (g) to the appropriate size, if necessary, and (i) clamping or otherwise constraining, if necessary, the assembly thus formed so it will maintain the appropriate shape. This process therefore requires a minimum of four steps beyond those necessary to form the rectangular array of scintillator pixels.

The sheet reflector process can be streamlined to a certain extent by forming a plurality of scintillator arrays in a single blank. Typically the grooves between the individual scintillator arrays will be at least twice as wide as those within a scintillator array. Two strips of reflector material are inserted into these wide grooves. If bonding is used, each strip in the double strip is bonded to the adjacent scintillator but not to its neighbor reflector strip. The individual scintillator assemblies will separate at the junction between the double strips during subsequent processing.

Fabricating scintillator array assemblies with sheet reflectors can also be performed using slab assembly. Making a scintillator assembly in this method requires (a) fabricating a plurality of “x-slabs” of scintillating material, each the thickness of the x-dimension of a pixel, (b) arranging the slabs into an “x-assembly” that has a stack of alternating x-slabs, with their x-dimension parallel to the x-axis and their y-z faces perpendicular to the x-axis, and reflector sheets of appropriate thickness, beginning and ending with a reflector sheet, in which each x-slab is bonded to a reflector sheet on each y-z face, typically by using an adhesive; in the case of a plurality of arrays, either a plurality of sheets of the reflector material is used between adjacent arrays, no adhesive typically being applied to one joint between sheets to permit separation of the arrays, or the thickness of the sheet reflector between adjacent arrays is sufficiently larger than that between scintillator pixels to permit cutting or otherwise separating the arrays, leaving an appropriate thickness of reflector on the outside of each array, (c) cutting the x-assembly of slabs in the y-direction, perpendicular to the layers of the stack, and passing through all the layers of sheet reflective material to yield “xy-slabs” of the composite of scintillating material and reflector, the thickness of which is equal to the y-dimension of a scintillator pixel, (d) repeating step (b) immediately above using the xy-slabs, to form an “xy-assembly”, (e) cutting the xy-assembly in the z-direction, perpendicular to both the x- and y-axes, if necessary, to form “xyz-slabs” of the desired z-dimension; in some cases this step may be performed earlier by cutting either a scintillator blank or the x-slabs in the z-direction to the desired dimension, (f) bonding a sheet reflector onto the top “z-surface”, parallel to the x-y plane, of each xyz-slab, and (g) if applicable, cutting or otherwise dividing each xyz-slab to separate the individual arrays. This process requires a minimum of three steps beyond those necessary to form a rectangular array of scintillator pixels.

Fabricating one or a plurality of scintillator array assemblies from scintillator arrays using cast-in-place reflectors can be performed using reflective paste, reflective gel, reflective solid, or another form of reflective material compatible with casting in place. Individual materials may change chemically, in material type, or otherwise during the reflectorizing process. A gel may, for example, change into a solid during processing. Any one or a plurality of these materials may be cast in place from one or more precursors that react, fuse, or otherwise change with time, singly or in conjunction with one or more additional process variables such as heat or pressure, to form the desired final reflector material. One example is the use of a precursor component or components (referred to below as solid precursors) that cure, with or without intentional heating, to form a solid reflective epoxy. The precursors may include inert materials to improve the properties of a precursor mixture on the final cast material. For example, a pigment or combination of pigments may be added to the precursors of an epoxy to enhance the reflectivity of the final epoxy. Fabricating a scintillator assembly by casting in place typically entails at a minimum (a) cutting or otherwise forming one or more scintillator arrays from a single solid “blank” of scintillator, (b) placing the scintillator array or arrays in a container or cavity of a desired shape (often referred to as a mold in reference to casting processes), typically with one open face referred to as the top; if a plurality of scintillator arrays is to be cast in one step, the spaces between the individual arrays typically will be at least twice the width of the spaces within an array), (c) filling or overfilling the container with reflective paste, reflective gel, or precursor or precursor of the paste or gel, or a solid precursor or precursors, with or without addition of a pigment or a plurality of pigments or one or a plurality of other additives or any combination of pigments and other additives, (d) agitating, applying vacuum to, or otherwise manipulating the materials of (c) to minimize the number of bubbles entrained within, (e) curing, fusing or otherwise modifying these materials as appropriate to form the final desired material, (f) machining, scraping, or otherwise thinning the top surface of the final reflector to the desired thickness, (g) separating individual scintillator assemblies thus formed by sawing, cutting or other means if applicable, and (h) clamping or otherwise constraining the assembly thus formed, if appropriate, so it will maintain the appropriate shape. This process therefore requires a minimum of four steps beyond those necessary to form a rectangular array of scintillator pixels.

Previous techniques may result in an inconsistent increase in the level of light emitted from the exit windows of a plurality of scintillator pixels. Gaps between pieces of Teflon tape, or thinned regions of the tape formed if the tape is stretched too tightly (particularly where the tape crosses an edge of a scintillator pixel) can form areas where the thickness of the tape is too low to provide the desired reflectivity. Similarly, nicks introduced during cutting through sheet reflector material can leave portions of the scintillator surface area with too thin a reflective layer or no reflective layer at all. Gaps between the side reflectors and the top reflector at the outer edges of the scintillator assembly can similarly result in light loss or in difficulties maintaining alignment during optical coupling. Bubbles in the bond line formed during attachment of reflector strips to the scintillator can reduce the level of light emitted by the exit window. Bubbles in reflective pastes, gels or solids can have a similar effect.

Ideally, the reflector material would have a reflectivity of 100%. In practice, the materials discussed typically have reflectivity in the range 90-99% depending on thickness. In typical cases, a secondary or scintillation photon “bounces off” the reflector multiple times. At a minimum, averaged over many photons, the light loss due to absorption within the reflector material will be (100%—reflectivity in percent) times (average number of reflections). The average number of reflections is primarily determined by the geometry of the individual pixel. Therefore, the larger the reflectivity of the reflector material, the higher the light output from each pixel.

The requirement that tape used to wrap scintillator pixels be highly flexible limits the choices for the tape material to those that wrap easily around the scintillator pixels in appropriate thickness. The requirement that the tape be highly reflective further limits the available choices. In cases where the tape consists of a transparent flexible matrix into which is mixed a reflective filler such as one or a plurality of pigments such as titanium dioxide, one or a plurality of other additives, or any combination of pigments and additives, the need for high flexibility may limit the maximum useful concentration of the filler to levels below those that would maximize the reflectivity of the tape.

Forming scintillator assemblies by casting in place the reflector material imposes several limitations on the choice of the reflector material and the precursors or components necessary to cast the material. The process of forming the reflector must not degrade the properties of the scintillator. Therefore, the reflector material and its components or precursors must be chemically compatible with the scintillator material. For example, several scintillator materials such as sodium iodide, lanthanum chloride and lanthanum bromide are hygroscopic. The process used to cast reflectors for these materials must not release water at any point in the process. Scintillator materials such as thallium-doped cesium iodide degrade when exposed to elevated temperatures. The casting process for such materials therefore must not involve heating the scintillator, either to cure the material or by exothermic heat produced as a result of the chemical reactions involved in the curing process, to temperatures at which the scintillator would degrade during the period in which the temperature of the scintillator is elevated.

### SUMMARY

A scintillator assembly as described herein has one or a plurality of scintillator pixels, the surface area of which is partially covered by a reflector assembly, at least a portion of the reflector assembly having been pre-formed into a desired configuration prior to insertion of at least one scintillator pixel.

In embodiments, the reflector assembly may comprise a single pre-formed unit or a plurality of subassemblies, one or a plurality of which having been pre-formed prior to insertion of one or a plurality of scintillator pixels. The term pre-formed reflector or PFR denotes a single pre-formed reflector assembly or the totality of pre-formed reflector subassemblies employed in an embodiment. The reflector assembly covers at least a portion of the exterior surface of a scintillator pixel or an array of scintillator pixels but does not cover the surface of any exit window of any pixel or plurality of pixels. In embodiments involving a plurality of reflector subassemblies, one or a plurality of scintillator pixels may be inserted into one or a plurality of the pre-formed reflector subassemblies prior to completion of reflector assembly.

Scintillator assemblies may be formed using one or a plurality of pre-formed reflector subassemblies in conjunction with one or a plurality of reflector subassemblies formed by any prior art method or by any combination of prior art methods.

In some embodiments, the PFR may provide for the formation of one or a plurality of intentional air gaps between one or a plurality of reflector walls and one or a plurality of scintillator pixels.

### DESCRIPTION OF DRAWINGS

These and other features and advantages of the invention will become more apparent upon reading the following detailed description and upon reference to the accompanying drawings.

FIGS. 1a-1c depicts three stages in the fabrication of a scintillator array assembly using an embodiment of a pre-formed reflector.

FIGS. 2a-2c illustrate two stages in the reflectorizing of a single pixel with tapered regions using an embodiment of a pre-formed reflector comprising two pre-formed subassemblies and a cross-section through the completed assembly showing a joint between the two subassemblies of the pre-formed reflector in this embodiment.

### DETAILED DESCRIPTION

A scintillator assembly has one or a plurality of scintillator pixels, the surface area of which is partially covered by a reflector assembly, at least a portion of said reflector assembly having been formed into a desired configuration prior to insertion of one or plurality of scintillator pixels. The reflector assembly may have a single pre-formed unit or a plurality of subassemblies, one or a plurality of said subassemblies having been pre-formed prior to insertion of one or a plurality of scintillator pixels. The term pre-formed reflector or PFR denotes a single pre-formed reflector assembly or the totality of pre-formed reflector subassemblies employed in an embodiment. The PFR covers at least a portion of the exterior surface of a scintillator pixel or an array of scintillator pixels but does not cover the surface of any exit window or any plurality of exit windows. In embodiments involving a plurality of reflector subassemblies, a scintillator pixel or plurality of pixels may be inserted into one or a plurality of the reflector subassemblies prior to completion of the reflector assembly.

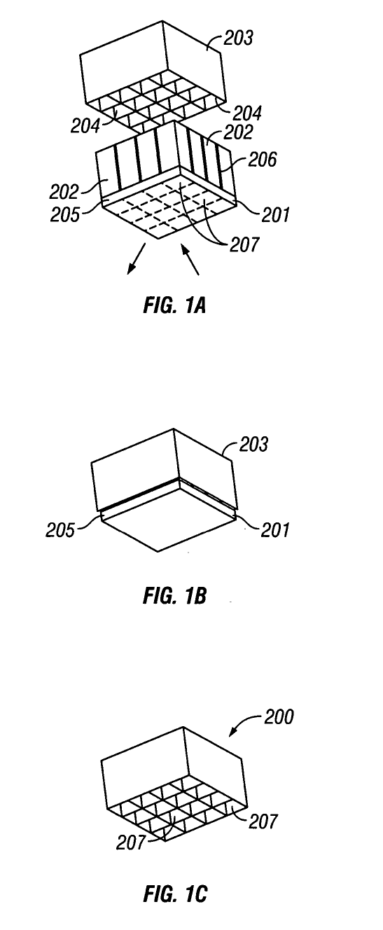

FIGS 1a-1c depict the process of forming a scintillator assembly 200 by inserting a four-pixel by four-pixel array 201 of scintillator pixels 202 as a single unit into a pre-formed reflector 203. In FIG. 1a, PFR 203, contains sixteen recesses 204, each recess having inner surfaces which are dimensioned appropriately to accept the outer surfaces of pixels 202 of the array 201, is positioned to facilitate insertion of array 201. In the embodiment shown, the pixels 202 of array 201 are held in the appropriate position relative to each other by surfaces of an exit window bridge 205 spanning the gaps 206 between the pixels 202. In some embodiments the exit windows 207 (hidden in FIG. 1a, but shown in FIG. 1c) of the pixels 202 may not have been formed at this stage of the process. For example, the exit window bridge 205 may be made of scintillator material left uncut in the fabrication of the gaps 206. In other embodiments the exit window bridge 205 may be formed of a material different from the scintillator and attached to the exit windows 207 of the pixels 202. For simplicity, the scintillator array 201 is denoted a scintillator array and the scintillator pixels 202 are denoted pixels, independent of whether the exit windows 207 have been formed. Similarly, the scintillator array 201 is treated as being separate from the exit window bridge 205, independent of whether the exit window bridge is formed of the scintillator material.

In FIG. 1b, the pixels 202 of scintillator array 201 have been inserted into the appropriate recesses of the PFR 203, leaving the exit window bridge 205 exposed.

FIG. 1c illustrates the final scintillator assembly, 200, comprised of the scintillator array 201 and the pre-formed reflector 203 after removal of the exit window bridge 205. Removing the exit window bridge 205 exposes the exit windows 207 of the exit windows of the scintillator pixels 202. In the embodiments described above and similar embodiments, fabricating a scintillator array assembly 200 requires only one or two process steps beyond those necessary to form the scintillator array 202 and its exit windows 207.

Fabrication of a scintillator array assembly 200 per FIG. 1c can also be performed by inserting single scintillator pixels 202, a plurality of scintillator arrays, each with fewer than sixteen pixels, or a combination of both single pixels and one or a plurality of scintillator arrays into the PFR 203 until all the recesses 204 are loaded with scintillator pixels.

Scintillator assemblies may be formed using one or a plurality of pre-formed reflector subassemblies and one or a plurality of reflector subassemblies formed by any prior art method or by any combination of prior art methods. For example, a scintillator subassembly with geometry similar to that of the scintillator assembly 200 in FIG. 1c may be formed by casting in place. A pre-formed reflector subassembly may then be added to create a new scintillator assembly in which the exit window of each scintillator pixel has an area smaller than the exit face of the pixel. One embodiment of such a PFR subassembly would be in the form of a cap comprising a horizontal portion covering the bottom face of the cast-in-place sub assembly, except for the desired exit window openings, and four vertical lips to permit slip-fitting or bonding the PFR subassembly to the vertical walls of the cast-in-place subassembly.

The elements of the scintillator array can be formed of a single material, or of multiple different materials.

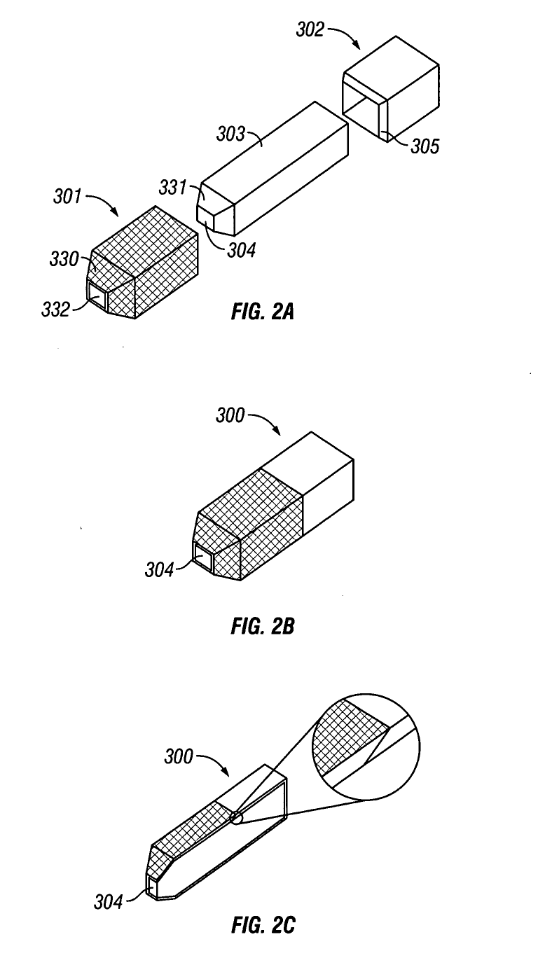

In some situations where, for example, (a) individual scintillator pixels or arrays of scintillator pixels have geometric features such as varying cross-sections parallel to the xy-plane, or (b) there is a need to cover a portion of one or a plurality of scintillator exit faces with reflector material, a plurality of pre-formed array reflector subassemblies may be used to form an appropriate pre-formed reflector. For example, FIGS. 2a-2c illustrate the use of two PFR subassemblies to cover the surface area of a scintillator with an exit window of smaller area than the cross-sections parallel to the exit face of the remainder of a scintillator pixel.

FIG. 2a depicts one stage in the fabrication of the scintillator assembly in accordance with this embodiment. A lower PFR subassembly 301 and an upper PFR subassembly 302 are positioned for insertion of a scintillator pixel 303. The lower PFR subassembly 301 has a tapered end section 330 designed to fit over a corresponding tapered end section 331 of the scintillator pixel 303. PFR 301 has a hole 332, leaving the exit window 304 exposed. The remainder of the lower PFR 301 covers a portion of the body of the scintillator pixel 303. The upper PFR covers the remainder of the body of the scintillator pixel 303.

A portion 305 of the upper PFR, adjacent to the open end of the upper PFR 302, is tapered inward on all four sides. Two of the tapered regions are visible. When the assembly is complete, the tapered regions 305 of the upper PFR 302 will mate with corresponding regions of the lower PFR 301 that are not visible in FIG. 2a. More generally, the pre-formed reflector has inner surfaces which are sized to press against the scintillator material 303, and form a press fit against that scintillator material. The press fit is formed by the inner surfaces of the reflector pressing against the outer surfaces of the scintillator. The press fit preferably occurs on at least two different sides of the scintillator to thereby apply force into different directions. Taper joints such as shown in the embodiment of FIGS. 2a-2c are only one of a plurality of possible types of joints between subassemblies of a PFR.

FIG. 2b illustrates the completed assembly 300 after insertion of the scintillator pixel 303 into both PFR subassemblies 301 and 302. FIG. 2c is a cross-sectional view of the completed assembly 200, with detail D providing an expanded view of the final configuration of the tapered portions of both PFR parts.

It may be desirable to leave an air gap, or a plurality of air gaps, between a solid scintillator and reflector. The “aspect ratio” of a scintillator pixel is the ratio between the total surface area of the pixel and the area of the exit window or windows. Without an air gap or gaps, the light output of scintillator assemblies—whether containing a single pixel or a plurality of pixels—with large pixel aspect ratios, may be reduced because each scintillation photon must be reflected numerous times before passing through the exit window. In this process, many photons are absorbed in the reflector. Pre-formed reflectors permit intentional inclusion of at least one air gap, thereby allowing reflection off the walls of the scintillator to occur by total internal reflection, which is a lossless process. Use of the techniques disclosed herein may therefore result in increased light output compared to the equivalent scintillator assembly without the air gap or air gaps.

In some embodiments, it is desirable for the pre-formed reflector material to have an appropriate level of flexibility (a) to allow individual scintillator pixels, or a complete array of scintillator pixels held together by material formed over and bridging between their exit faces, to be pressed easily into the recess or recesses in the pre-formed reflector and (b) to allow the pre-formed reflector to accept scintillator pixels within the desired range of pixel sizes. In cases where the pre-formed reflector may not provide a snug fit for pixels within some range of sizes, a variety of provisions can be made to ensure that the scintillator pixels remain in place during use and to control the effect of any voids resulting from dimensional mismatch between the reflector and the scintillator pixels. For example, as an alternative to the press fit, the individual scintillator pixels may be held in position by bonding exit faces of the scintillator assembly to the input window or windows of the photodetector. This technique may also be used in some embodiments in which the recess or recesses in the pre-formed reflector are intentionally oversized to facilitate formation of air gaps between the scintillator pixels and the reflector.

The intentional inclusion of air gaps reduces the rigidity of the scintillator assembly structure and may therefore be useful in reducing stresses caused by difference temperature coefficient of expansion between the scintillator material and the reflector material and also between the scintillator assembly and any surface, such as the face of a photomultiplier tube, to which the assembly is bonded or otherwise rigidly attached.

In some embodiments requiring air gaps, the scintillator pixels may be held in position away from the walls of the reflector by ribs or other protrusions molded into the walls of the reflector recesses. The scintillator may be bonded the scintillator pixels to the pre-formed reflector by a thin layer of adhesive applied to one or more faces of the pixel. This method is applicable in embodiments with or without intentional air gaps, although it may degrade either or both of the light yield and uniformity of light output of the scintillator/reflector assembly.

Scintillator assemblies with pre-formed reflectors may be fabricated for a plurality of pixel sizes.

The disclosed process adapts readily to the fabrication of scintillator assemblies with a plurality of exit windows for each pixel or to assemblies in which the exit windows of the pixels occupy only a portion of the face containing the exit window. Reflectorizing scintillator assemblies in which the pixels are not rectangular parallelepipeds by wrapping and or using sheet reflector material may greatly increase the complexity of the process. This is particularly true if the individual pixels are tapered over at least part of their surface. Making scintillator assemblies in which the exit windows are not perpendicular to the adjacent sides of each pixel may require a similar increase in complexity using sheet reflectors or casting in place.

The techniques can be applied, for example, to scintillator assemblies with more than one exit face per pixel, with more than one exit window per pixel, with exit windows of smaller area than the face or faces on which the exit windows reside, or any combination of these configurations. They can also be applied to, for example, (a) a single pixel or a plurality of pixels of non-rectangular cross-section (e.g., pixels of hexagonal cross-section or parallelogram cross-section, pixels where the planes of the top face, bottom face or both are not parallel to the x-y plane, pixels where the sides other than the top and bottom faces are not parallel to the z-direction but are parallel to a single axis not lying in the x-y plane, pixels where the sides other than the top and bottom faces are non-parallel, pixels tapered in the z-direction or in a direction parallel to a single axis not lying in the x-y plane), (b) arrays of a plurality of scintillator pixels, one or a plurality of which have different cross-sections from one or a plurality of other pixels in the array, (c) arrays in which the individual pixels are not distributed in a rectangular array, and (d) any appropriate combination of (a), (b), (c) individually or collectively.

Additionally the techniques are applicable to scintillator pixels with exteriors partially or completely defined by curved, surfaces, such as cylindrical scintillators and scintillators with exit windows curved to act as lenses. For consistency with the text above, such surfaces can be considered to be faces of the scintillator, in the sense that face denotes a distinct portion of the surface area of a scintillator pixel, independent of whether said portion of the surface area is planar.

The embodiment can be applied to configurations where one or a plurality of exit windows is internal to one or a plurality of scintillator pixels. Examples are scintillator assemblies with pixels into which, or through which, one or a plurality of optical fibers or other light collection apparatus is inserted. Pre-formed reflectors permit advantageous uses of optical fibers for light collection, for other uses such as wavelength shifting, or for any combination of light collection and other uses. In such situations, an optical fiber typically enters a pixel of the scintillator assembly by passing through a hole in the reflector assembly. It may then enter into an air gap between the scintillator pixel and the corresponding walls of the reflector assembly, enter directly into a hole in the scintillator pixel, or pass through an air gap and subsequently enter a hole in the scintillator pixel, said hole either terminating within the scintillator pixel or passing through the scintillator pixel. Similarly, although an individual optical fiber may exit a pixel of the scintillator assembly by passing through its entry hole in the reflector assembly, an individual optical fiber typically exits a pixel of the scintillator assembly through a different hole in the reflector assembly. An individual fiber may exit a pixel of the scintillator assembly by passing directly through an air gap, by exiting a through hole in the scintillator pixel directly into a hole in the reflector assembly, or by exiting a through hole in the scintillator pixel and passing through an air gap and exiting through a hole in the reflector wall. A single fiber may pass through one or a plurality of pixels of the scintillator assembly before finally stopping within the scintillator assembly or exiting the scintillator assembly.

The formation of air gaps in desired locations within the scintillator assembly may produce unique advantages in embodiments that require one or a plurality of fibers to enter into or pass through one or a plurality of air gaps within the scintillator assembly.

The pre-formed reflector may be formed using molding procedures such as injection molding, which is capable of producing essentially identical parts with high dimensional accuracy and low cost.

Pre-forming the reflector allows the use of materials that may have been difficult to use with other techniques. For example, polyethylene, which is incompatible with casting in place in applications involving cesium iodide because the required temperatures would cause degradation of the scintillator material. Because pre-formed reflectors are formed without the presence of the scintillator material, they can be fabricated using chemicals or process steps incompatible with a given scintillator, such as fabrication using materials that have components or precursors chemically incompatible with the scintillator prior to completion of the formation process. For example, hygroscopic scintillators such as sodium iodide can be used with reflector materials that evolve water during curing.

Physical embodiments of scintillator assemblies incorporating pre-formed reflectors have been made with single scintillator pixels and with four-pixel x four-pixel arrays of thallium-doped cesium iodide scintillator material. Pixel sizes of roughly 3 mm (x-direction)×3 mm (y-direction)×6 mm (z-direction) and 6 mm (x-direction)×6 mm (y-direction)×6 mm (z-direction) were used. These embodiments do not restrict the disclosure to a specific size or specific sizes of pixels. The physical configuration of the final scintillator array assembly is, except for scale, as shown in FIG. 1c. Polyethylene filled with several different concentrations of titanium dioxide was injection molded to form single-unit pre-formed reflectors that were subsequently filled with scintillator pixels. We used both insertion of individual pixels and insertion of sixteen pixel scintillator array subassemblies with exit window bridges to form final the scintillator assemblies.

Other materials besides polyethylene or titanium dioxide can be used as components of a reflector material, and moreover, techniques other than injection molding can be used to fabricate pre-formed reflectors. A large variety of other pigments, such as the aluminates, carbonates, chlorides, fluorides, hydrides, oxides, oxybromides, oxychlorides, oxyfluorides, molybdates, phosphates, sulfates, tungstates and other reflective inorganic compounds of metals, may be used singly or in combination as reflective additives to polyethylene or other reflector materials. Some specific examples are aluminum oxide, aluminum orthophosphate, antimony trioxide, antimony tetroxide, barium oxide, barium carbonate, barium molybdate, bismuth oxybromide, bismuth oxychloride, bismuth oxyfluoride, calcium aluminate, calcium hydride, calcium peroxide, calcium trialuminate, calcium triorthophoshate, calcium tungstate, hafnium oxide, lanthanum oxide, magnesium carbonate, magnesium oxide, strontium peroxide, tin dichloride, zinc oxide, zirconium tetrachloride, and zirconium tetraflouride.

Pre-formed reflectors may be formed using reflector materials that, singly or in conjunction with one or more additives, perform additional functions such as wavelength shifting or “brightening” to enhance or degrade light output at particular frequencies or ranges of frequencies. Additives that may be useful for wavelength shifting include, but are not limited to, one or a plurality of scintillating materials such as barium fluoride, cerium-activated bismuth germanium oxide (BGO), cadmium tungstate, sodium-doped cesium iodide, thallium-doped cesium iodide, cerium fluoride, europium-doped calcium fluoride, terbium-activated glass, europium-doped lithium, cerium-activated lithium glass, cerium-activated gadolinium silicate (GSO), lanthanum bromide, lanthanum chloride, thallium-doped sodium iodide, cerium-activated yttrium aluminum garnet (YAG), cerium-activated yttrium aluminum perovskite (YAP), cerium-activated lutetium orthoaluminate (LuAP), and cerium-activated lutetium orthosilicate (LSO). Organic scintillators and other organic optical brighteners may also be used. Pre-formed reflectors may perform the task of high-energy photon shielding if one or a plurality of high-density, high Z filler materials such as tungsten, lead, lead oxide, hafnium oxide, lanthanum, lanthanum oxide, bismuth, bismuth oxychloride, bismuth oxyflouride, and other inorganic compounds of heavy metals is added. Use of the elemental metals will reduce light output.

Embodiments incorporating one or more pre-formed reflector assemblies fabricated using a supporting matrix pre-formed to the desired shape and coated with reflector material by painting or other forms of deposition are within the scope of the invention.

Reflectivities derived from experimental data, using realistic models of the effects of scintillator and reflector geometry and reflector reflectivity, agree well with accepted values for two types of reflector material. In polyethylene, the light output—and by deduction, the reflectivity of the reflector material—from scintillator assemblies of the same size and physical arrangement of pixels increases with increasing titanium dioxide concentration until a limiting concentration is reached, beyond which polyethylene does not mold properly. At a certain titanium dioxide concentration, we observed light output from the exit windows corresponding to a reflectivity higher than the reflectivities of a well-known sheet reflector material and a titanium dioxide-filled epoxy material we have used to fabricate cast-in-place reflectors for scintillator array assemblies of the same configuration.

A number of embodiments have been described. Nevertheless, it will be understood that various modifications may be made without departing from the spirit and scope of the invention. Accordingly, other embodiments are within the scope of the following claims. For example, other materials could be used. Other shapes and numbers of scintillator pixels could be used; as well as other geometric shapes to arrays. All such embodiments are intended to be encompassed within the following claims, in which:

1. A scintillator assembly, comprising:
a scintillator material, having outer surfaces of a first shape; and
a preformed reflector, having inner surfaces which mate with said first shape to contain said scintillator material at least partly within said pre-formed reflector.

2. An assembly as in claim 1, wherein said inner surfaces of said pre-formed reflector press against outer surfaces of said scintillator material to hold said scintillator material within said preformed reflector.

3. An assembly as in claim 1, further comprising an adhesive material, bonding said scintillator material is bonded within said pre-formed reflector.

4. An assembly as in claim 2, further comprising ridges within said preformed reflector, holding said scintillator material within said preformed reflector.

5. An assembly as in claim 1, further comprising an opening in the preformed reflector, at a specified location, corresponding to a specified location on the scintillator material.

6. An assembly as in claim 5, wherein said opening is at a location of an exit window within the scintillator material.

7. An assembly as in claim 5, wherein said opening is at a location of a light guide input to or output from the scintillator material.

8. An assembly as in claim 1, wherein said pre-formed reflector has inner surfaces for containing a plurality of separate units of scintillator material, forming a scintillator array.

9. An assembly as in claim 8, further comprising at least one air gap between a wall of the reflector and a surface of the scintillator material.

10. An assembly as in claim 9, further comprising a protrusion forming a spacer to form said air gap.

11. An assembly as in claim 1, further comprising a plurality of openings in the pre-formed reflector, at locations of a plurality of exit faces for the scintillator material.

12. An assembly as in claim 1, wherein the pre-formed reflector is formed of multiple pieces.

13. The scintillator assembly of claim 1, in which at least one pixel has at least one exit window smaller than the area of a face of the pixel upon which each said exit window is defined.

14. The scintillator assembly of claim 1, in which one or a plurality of scintillator pixels is shaped other than a rectangular parallelepiped.

15. The scintillator assembly of claim 1, in which the assembly comprises a plurality of pixels of scintillator material and reflector, positioned in an array.

16. The scintillator assembly of claim 1, in which the assembly comprises an array of a plurality of scintillator pixels of scintillator material and reflector, and in which at least one scintillator pixels comprises at least one scintillator material differing from a scintillator material of an other scintillator pixels in said array.

17. The scintillator assembly of claim 1, in which at least one of the scintillator materials varies in cross-sectional area in at least one direction.

18. The scintillator assembly of claim 1, in which at least one of said scintillator materials has at least one exit face that is not perpendicular to adjacent sidewalls of the material.

19. The scintillator assembly of claim 1, in which the reflector assembly is sufficiently flexible to permit insertion of scintillator material by press fitting.

20. The scintillator assembly of claim 1, further comprising at least one optical fiber inserted into said scintillator material.

21. The scintillator assembly of claim 20, in which said optical fiber is used for wavelength shifting.

22. The scintillator assembly of claim 9, further comprising at least one optical fiber inserted into or passing through one or a plurality of air gaps between one or a plurality of scintillator pixels and the corresponding pixels of the reflector assembly.

23. The scintillator assembly of claim 22, in which said at least one optical fiber is used for wavelength shifting.

24. The scintillator assembly of claim 1, further comprising at least one of inorganic or organic materials as an additive to the reflector material of a pre-formed reflector assembly.

25. The scintillator assembly of claim 24, in which titanium dioxide is an additive to the reflector material of a pre-formed reflector assembly or to the reflector material of one or a plurality of pre-formed reflector subassemblies.

26. The scintillator assembly of claim 24, in which oneor a plurality of aluminum oxide, aluminum orthophosphate, antimony trioxide, antimony tetroxide, barium oxide, barium carbonate, barium molybdate, bismuth oxybromide, bismuth oxychloride, bismuth oxyfluoride, calcium aluminate, calcium hydride, calcium peroxide, calcium trialuminate, calcium triorthophoshate, calcium tungstate, hafnium oxide, lanthanum oxide, magnesium carbonate, magnesium oxide, strontium peroxide, tin dichloride, zinc oxide, zirconium tetrachloride, and zirconium tetraflouride is an additive to a material of the reflector.

27. The scintillator assembly of claim 24, in which one or a plurality of high-Z, high-density materials such as bismuth, bismuth oxychloride, bismuth oxyflouride, gold, hafnium, hafnium oxide, iridium, lanthanum, lanthanum oxide, lead, lead oxide, osmium, platinum, platinum phosphide, rhenium, tantalum, tungsten, and other inorganic compounds of heavy metals is an additive to a material of the reflector.

28. The scintillator assembly of claim 24, in which at least one scintillating material such as barium fluoride, cerium-activated bismuth germanium oxide (BGO), cadmium tungstate, sodium-doped cesium iodide, thallium-doped cesium iodide, cerium fluoride, europium-doped calcium fluoride, terbium-activated glass, europium-doped lithium, cerium-activated lithium glass, cerium-activated gadolinium silicate (GSO), lanthanum bromide, lanthanum chloride, thallium-doped sodium iodide, cerium-activated yttrium aluminum garnet (YAG), cerium-activated yttrium aluminum perovskite (YAP), cerium-activated lutetium orthoaluminate (LuAP), cerium-activated lutetium orthosilicate (LSO) and organic scintillators is an additive to the material of the reflector.

29. The scintillator assembly of claim 1, in which one or a plurality of organic optical brightening agents is an additive to the reflector.

30. The scintillator assembly of claim 1, in which at least one reflector assembly is formed of polyethylene filled with one or a plurality of additives.

31. The scintillator assembly of claim 30, further comprising titanium dioxide as an additive to polyethylene.

32. The scintillator assembly of claim 30, in which at least one of aluminum oxide, aluminum orthophosphate, antimony trioxide, antimony tetroxide, barium oxide, barium carbonate, barium molybdate, bismuth oxybromide, bismuth oxychloride, bismuth oxyfluoride, calcium aluminate, calcium hydride, calcium peroxide, calcium trialuminate, calcium triorthophoshate, calcium tungstate, hafnium oxide, lanthanum oxide, magnesium carbonate, magnesium oxide, strontium peroxide, tin dichloride, zinc oxide, zirconium tetrachloride, and zirconium tetraflouride is an additive to the reflector assembly of a pre-formed reflector assembly or to the reflector material of one or a plurality of pre-formed reflector subassemblies.

33. The scintillator assembly of claim 30, in which one or a plurality of high-Z, high-density materials such as bismuth, bismuth oxychloride, bismuth oxyflouride, gold, hafnium, hafnium oxide, iridium, lanthanum, lanthanum oxide, lead, lead oxide, osmium, platinum, platinum phosphide, rhenium, tantalum, tungsten, and other inorganic compounds of heavy metals is an additive to the reflector assembly of a pre-formed reflector assembly or to the reflector material of one or a plurality of pre-formed reflector subassemblies.

34. The scintillator assembly of claim 30, in which one or a plurality of scintillating materials such as barium fluoride, cerium-activated bismuth germanium oxide (BGO), cadmium tungstate, sodium-doped cesium iodide, thallium-doped cesium iodide, cerium fluoride, europium-doped calcium fluoride, terbium-activated glass, europium-doped lithium, cerium-activated lithium glass, cerium-activated gadolinium silicate (GSO), lanthanum bromide, lanthanum chloride, thallium-doped sodium iodide, cerium-activated yttrium aluminum garnet (YAG), cerium-activated yttrium aluminum perovskite (YAP), cerium-activated lutetium orthoaluminate (LuAP), cerium-activated lutetium orthosilicate (LSO) and organic scintillators is an additive to the reflector assembly of a pre-formed reflector assembly or to the reflector material of one or a plurality of pre-formed reflector subassemblies.

35. The scintillator assembly of claim 30, in which one or a plurality of organic optical brightening agents is an additive to the reflector assembly of a pre-formed reflector assembly or to the reflector material of one or a plurality of pre-formed reflector subassemblies.

36. The scintillator assembly of claim 30, in which the pre-formed reflector assembly is formed by injection molding.

37. A method, comprising:
pre-forming a reflector of a specified shape having specified shaped inner surfaces; and
attaching said reflector to a scintillator material of a shape that fits within said inner surfaces.

38. A method as in claim 37, wherein said attaching comprises using pressure of an outer surface of said scintillator material against a pressure of an inner surface of said reflector to hold said scintillator material within said reflector.

39. A method as in claim 37, further comprising attaching said scintillator material to said reflector by an adhesive.

40. A method as in claim 37, wherein said preformed in comprises pre-forming a reflector having at least one opening therein.

41. A method as in claim 40, wherein said at least one opening mates with an exit window within the scintillator material.

42. A method as in claim 40, wherein said at least one opening includes a light guide input to or output from the scintillator material.

43. A method as in claim 37, wherein said reflector has a specified shape to hold a plurality of separate units of scintillator material.

44. A method as in claim 43, further comprising forming at least one air gap between adjacent scintillator material surfaces.
